(19) United States
(12) Patent Application Publication
(10) Pub. No.: US 2007/0231666 A1
(43) Pub. Date: Oct. 4, 2007

(54) Fuel cell interconnect

(76) Inventors: Conghua Wang, West Windsor, NJ (US); James Edward Doty, Skillman, NJ (US)

Correspondence Address: PATENT DOCKET ADMINISTRATOR;LOWENSTEIN SANDLER P.C., 65 LIVINGSTON AVENUE, ROSELAND, NJ, 07068, US

(21) Appl. No.: 11/236,148

(22) Filed: Sep. 27, 2005

Related U.S. Application Data
(60) Provisional application No. 60/613,659, filed on Sep. 28, 2004.

(51) Int. Cl. H01M 8/24

(52) U.S. Cl. 429/38

(57) ABSTRACT

Provided, in one embodiment, is a fuel cell interconnect comprising: a first primary conduit located at the periphery of the interconnect; a second primary conduit located at the periphery of the interconnect; a fuel cell distribution plate located at the top or bottom of the interconnect adapted to interface with a fuel cell and comprising: (i) an internal distribution conduit through the fuel cell distribution plate, and (ii) two or more second distribution conduits through the fuel cell distribution plate located peripheral to the internal distribution conduit but interior to the primary conduits, the internal and second distribution conduits adapted to convey fluid from one to the other along the top or bottom, as relevant, of the interconnect; and one or more manifold plates comprising a conduit from the first primary conduit to the internal distribution conduit and a conduit from the second primary conduit to two or more said second distribution conduits.

The present invention relates to interconnect structures for electrically connecting a fuel cell stack while providing fuel and oxidant flow management.

A fuel cell is an electrochemical device that generates electricity through the electrode reactions of fuel and oxidants (typically air). As long as fuel and oxidant are supplied, electricity can be generated continuously. The advantages of fuel cells include high efficient, low emission, and high reliability.

A fuel cell includes a cathode (oxidant electrode), an electrolyte and an anode (fuel electrode). The electrolyte is an ionic conductor/electronic insulator, sandwiched between the cathode and anode as a gas tight membrane. To increase voltage and current, it is desirable to make larger sized fuel cells by using large area fuel cells (to obtain larger current) and connecting single cells in series (to obtain higher voltage). The electrical connections between individual cells are achieved by using of electrical interconnects, which should also provide effective oxidant and fuel passageways.

Fuel cells using a solid oxide electrolyte (SOFCs) are the promising for power generation. The solid oxide electrolyte is either an oxygen ionic conductive or proton conductive oxide material. Due to the low electrolyte ionic conductivity at low temperature, SOFCs work at elevated temperatures (>400° C., typically >650° C.). The high working temperature brings advantages of high power density and high fuel efficiency. But high temperature create challenges to cell stack and manifold design, including thermal stress in cell structure due to unavoidable temperature gradients, materials compatibility, and stability of cell stack components.

Among all fuel cell stack designs, a tubular cell stack is among the most advanced. Such a stack can be constructed in large size without a seal requirement, as taught in U.S. Pat. No. 4,876,163. However, the tubular cell design is expensive to fabricate, and has a relative low power density due to the high internal resistance of the supporting cathode tube.

An alternative to the tubular cell is a planar cell where flat cell disks (trilayer cathode/electrolyte/anode) and interconnect plates (which conducts electrons between cells) are connected in series. The most common structure, as taught in U.S. Pat. No. 5,993,986, is a cross-flow cell stack, as shown in FIG. 1 (numbering as in cited patent for its FIG. 6). The cells are fabricated as a square plate. Gas passageway channels are built in the interconnect plate. A common interconnector material is a suitable ferric alloy. The stack could be manifolded to supply fuel or oxidant either externally or internally. The planar fuel cell stack has advantages of compact size, and low internal electrical resistance. However, fuel cell stacks using square shaped cell disks have drawbacks of extensive sealing requirements, and asymmetrical temperature distribution that is imposed by the flow field and associated asymmetrical electrode reactions. The asymmetrical temperature distribution results in a high thermal stress across the cell disks, which stress can potentially concentrate at the corners of the cell disk, causing failure of the cell stack during operation.

An alternative to the cross-flow square cell design is a radial co-flow design. As shown in FIG. 2 (numbering as in cited patent for its FIG. 2), U.S. Pat. No. 5,399,442 teaches a radial co-flow cell stack design using annular shape cells (cathode/electrolyte/anode tri-layers). Two tubes provide fuel and air flows through the hole in the center of the cell disks. Cathodes are protected from the contact of fuel gas and anode are protected from contacting of air by using tubular gaskets to form seals on the cell disk edges. Several other similar designs have are taught in U.S. Pat. No. 5,549,983, U.S. Pat. No. 4,910,100, U.S. Pat. No. 6,291,089, U.S. Pat. No. 4,770,955 and U.S. Pat. No. 5,589,285. Generally, these designs have disadvantages of extensive sealing requirements, non-symmetrical position of gas tubes resulting in non-uniform flow, and the difficult stack manifolding.

Another example of radial fuel cell stack design uses circular cell disks and interconnects having holes along the peripheries to provide fuel and oxidant inlets and outlets, as taught in U.S. Pat. No. 4,490,445 (see FIGS. 3A and 3B, numbering as in cited patent for its FIGS. 2 and 3) and U.S. Pat. No. 4,048,385. This design has significant disadvantages of an extensive interface to be sealed, non-uniform gas distribution and weak mechanical strength along the cell edge due to multiple holes for gas transit.

U.S. Pat. No. 5,851,689 teaches a design that uses plain planar circular cell disks (without hole on the cell disk) to build a cell stack. As shown in FIG. 4 (numbering as in cited patent for its FIG. 4), the manifolds to provide oxidant and fuel gases to each individual cells are complicated. Because of the narrow thickness of each individual cells (˜2 mm) and the electrical insulating requirement between interconnects, it is very difficult to construct a fuel cell stack with this design.

In summary, current designs of fuel cell stack have some disadvantages in operation and fabrication process. Specifically, it is desirable to develop a radial flow fuel cell stack that minimizes the sealing interfaces, and obtains a symmetrical flow field. Such a stack can have a more symmetrical electrode reaction and temperature distribution for reliable high performance operation.

In addition, most fuel cells use hydrogen as the fuel reacting at the anodes, but the fuels most commonly available are hydrocarbon fuels, such as natural gas. Therefore, it can be necessary to convert hydrocarbon fuels to hydrogen. A common method to convert hydrocarbon fuels to hydrogen is by steam reforming reactions. The endothermic steam reforming reactions can take place either outside fuel cell stack (external reforming), or inside the fuel cell stack (internal reforming). Internal reforming has the advantage of high-energy efficiency obtained by directly using waste heat generated from fuel cell reactions to provide heat for reforming. However, most of current designs for internal reforming place the steam reforming reactions inside fuel cell anodes. The highly endothermic steam reforming reactions can further distort temperature symmetry, resulting in higher thermal stress. On-anode internal reforming can require high steam/carbon ratios for the feed gases, which can reduce fuel concentration and result in lower fuel utilization. Therefore it is desirable to design a cell stack that can conduct internal steam reforming away from, but close to, the anodes, such as inside interconnect structures.

### SUMMARY OF THE INVENTION

Provided, in one embodiment, is a fuel cell interconnect comprising: a first primary conduit located at the periphery of the interconnect; a second primary conduit located at the periphery of the interconnect; a fuel cell distribution plate located at the top or bottom of the interconnect adapted to interface with a fuel cell and comprising: (i) an internal distribution conduit through the fuel cell distribution plate, and (ii) two or more second distribution conduits through the fuel cell distribution plate located peripheral to the internal distribution conduit but interior to the primary conduits, the internal and second distribution conduits adapted to convey fluid from one to the other along the top or bottom, as relevant, of the interconnect; and one or more manifold plates comprising a conduit from the first primary conduit to the internal distribution conduit and a conduit from the second primary conduit to two or more said second distribution conduits.

Provided, in another embodiment, is a fuel cell interconnect construct comprising: a first primary conduit located at the periphery of the interconnect; a second primary conduit located at the periphery of the interconnect; a fuel cell layer; a ceramic distribution plate comprising on a top side channels connected to the first primary conduit and the second primary conduit; and sandwiched between the ceramic distribution plate and the fuel cell layer, an perforated metal layer, wherein the perforations convey gas from the channels to an electrode of the fuel cell layer.

### BRIEF DESCRIPTION OF THE DRAWINGS

FIGS. 1, 2, 3A and 4 show structures whose overall design is outside the current invention.

FIGS. 5A-5D show a fuel cell stack made up of repeat units, and an exemplary repeat unit.

FIGS. 6A-6B show another repeat unit design.

FIG. 7 shows an interconnect with one distribution layer per reactant gas.

FIG. 8 shows an interconnect with two distribution layers per reactant gas, which can be used to preheat gas with heat from the fuel cell.

FIG. 9 shows some alternative structures for a distribution layer.

FIGS. 10A-10D show a three layer interconnect with metal outer layers.

FIGS. 11A-11B show composite material used to provide CTE matching with the fuel cell disk.

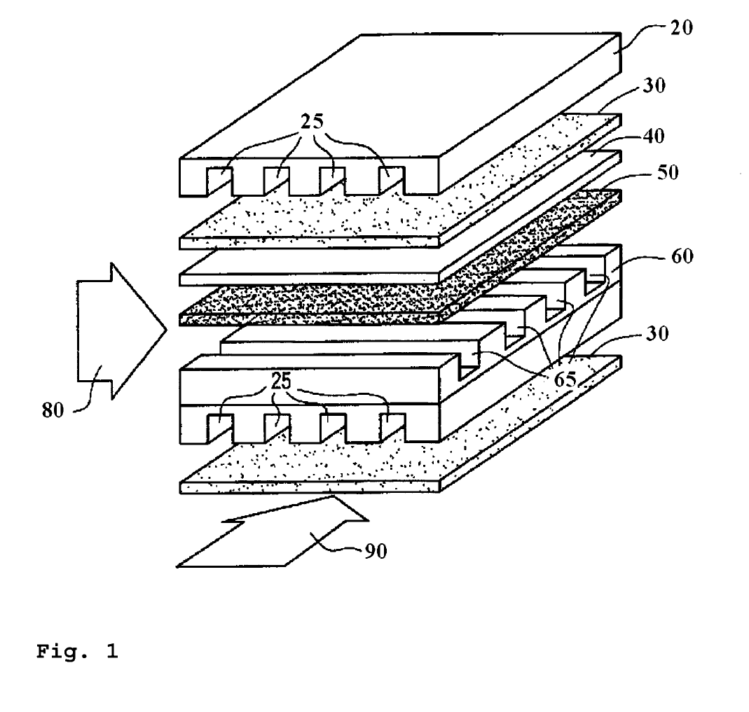

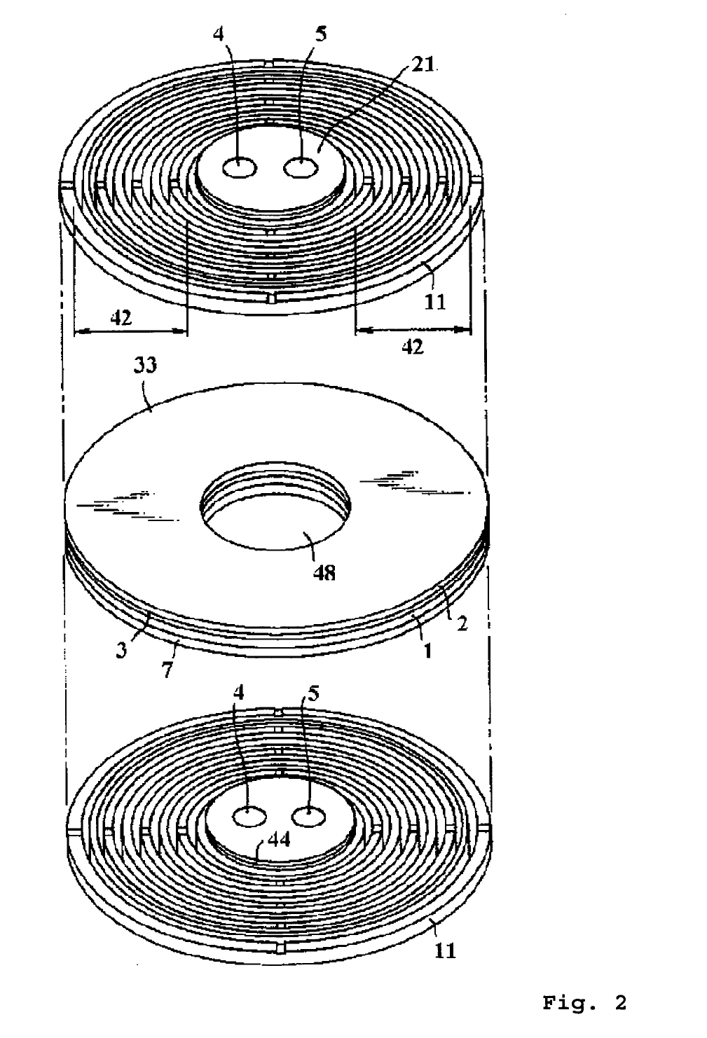

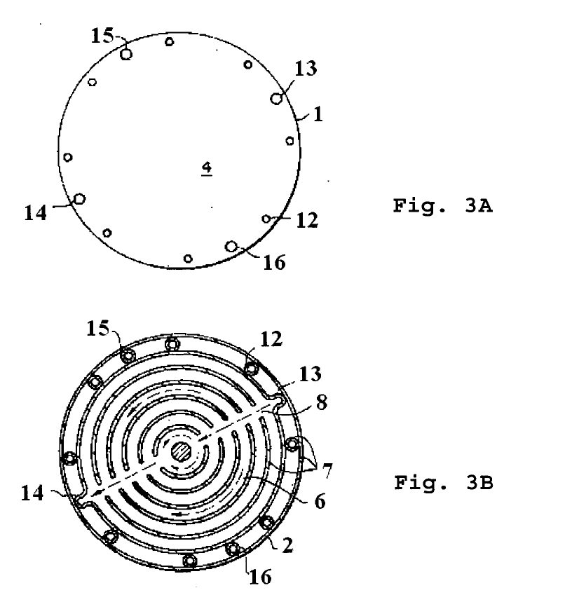

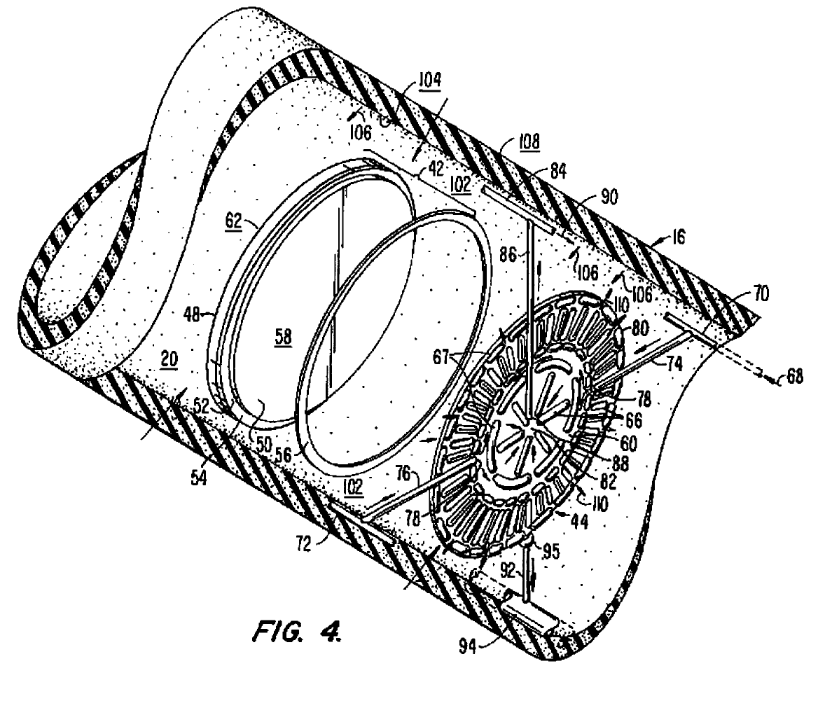

Definitions

The following terms shall have, for the purposes of this application, the respective meanings set forth below.

substantially round

Certain embodiments are well adapted for use with round fuel cell disks. A substantially round fuel cell is one whose edges stay within or touching two circles with diameters +15% and −15% of a reference circle.

aligned substantially with the center of the fuel cell

An internal distribution conduit is aligned substantially with the center of the fuel cell when its center is aligned within or touching a circle originating at fuel cell center and having diameter of 15% the smallest width of the fuel cell.

### DETAILED DESCRIPTION OF THE INVENTION

Center/Periphery Distributing Embodiments

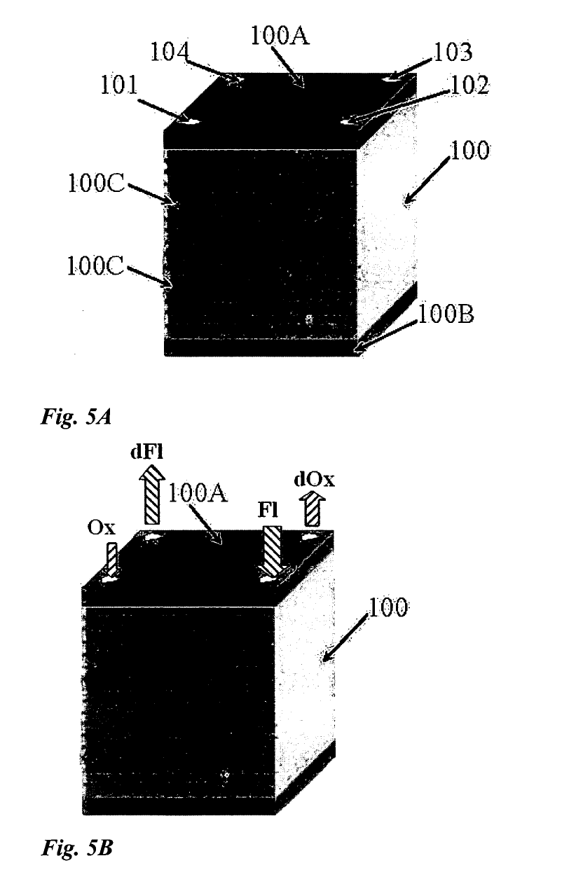

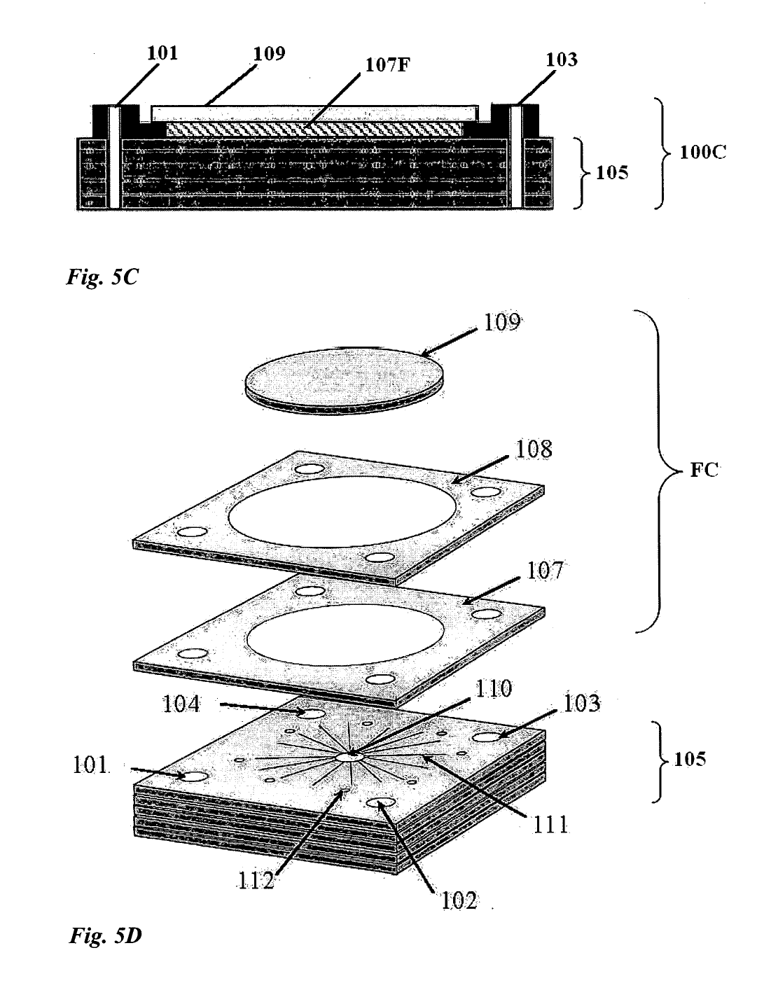

In one embodiment, a radial flow planar fuel cell stack is taught. This novel stack uses multi-layer interconnects for gas manifolding, and plain planar cell (cathode/electrolyte/anode tri-layer) structures (e.g., discs 109) for the electrical power generation. As illustrated in FIG. 5A, the planar fuel cell stack 100 can be constructed by a top plate 100A, a bottom plate 100B and a number of repeated cell units 100C. The four vertical primary conduits in the stack are for oxidant inlet 101, fuel inlet 102, deplete oxidant outlet 103 and deplete fuel outlet 104. Flow directions for oxidant Ox, fuel Fl, depleted oxidant dOx, and depleted fuel can be as illustrated in FIG. 5B.

An exemplary detailed structure of repeated cell unit 100C is shown in FIGS. 5B and 5D to include interconnect 105. A break-up view is shown in FIG. 5C. The fuel cell FC elements of exemplary repeat cell unit 100C can include a multi-layer interconnect 105, bonding glass 107, sealing glass 108 and planar fuel cell disk 109. It is useful to picture a stack of these fuel cell disks, such that interconnect 105 can be used to deliver, e.g., oxidant Ox to the cathode side of a fuel cell disc 109 in the repeat cell unit 100C and fuel Fl to a second fuel cell disc 109 in the next repeat cell unit 100C just below. Space 107C can be an open space, or can contain a porous material such as glass frit.

The shape of the cell disk 109 could be square, circular, elliptical and others, although circular is often useful. The cell disk 109 can be bonded on the multi-layer interconnect 105 using, for example, bonding glass 107. The repeat cell units are assembled to a cell stack using, for example, sealing glass 108. The feeding gas (such as oxidant gas) comes out of the internal distribution conduit 110 at, for example, the center of the multi-layer interconnect, then flows radially for example along optional radial channels 111. Radial channels 111 are optional aids to gas flow. In the absence of these channels, flow may be, for example, through space 107F or in the typically porous electrode. The gas then reacts on the relevant electrode. The gas can of course be pressurized to flow in the opposite direction. Then, the deplete gas flows back into the multi-layer interconnect through second distribution conduits 112. On the other side of the multi-layer interconnect (the bottom, assuming the illustrated orientation), the complimentary gas (such as fuel) feeds through an internal distribution conduit (separately connected to source gas as described below), flows radially to allow reaction at the complimentary electrode, and flows back into the multi-layer interconnect through other second distribution channels. The feeding and deplete gases are manifolded inside the multi-layer interconnect 105, and flow in/out of the repeated cell unit through primary conduits 101, 102, 103, and 104 illustrated at the corners of the repeated cell unit 105.

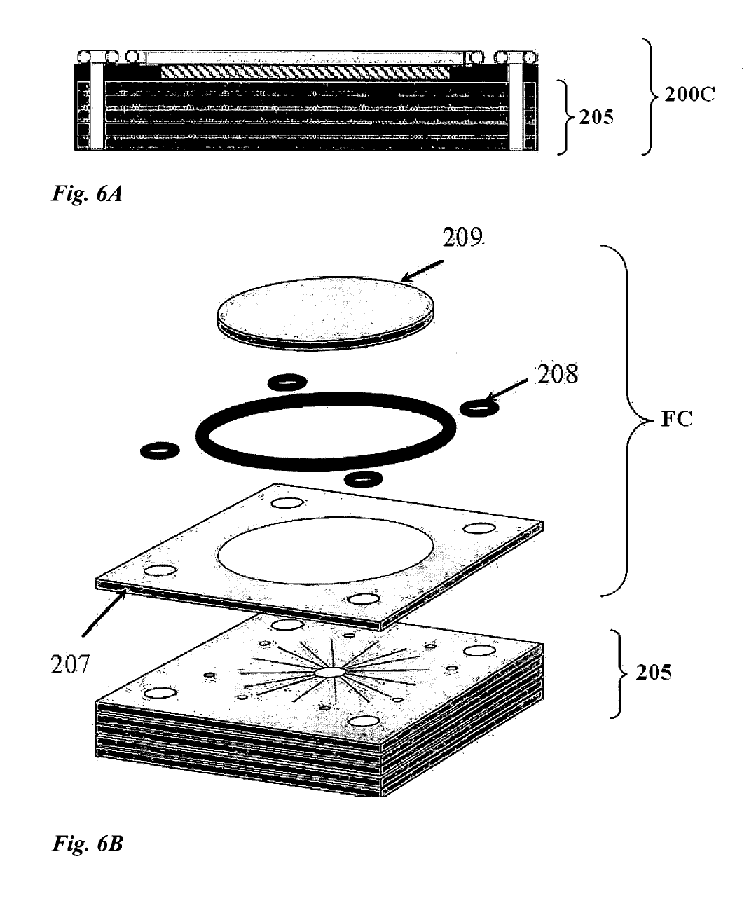

In another embodiment, gas sealing is accomplished with gaskets 208. As illustrated in FIGS. 6A and 6B, the repeated cell unit 200C is constructed by a multi-layer interconnect 205, bonding glass 207 and planar fuel cell disk 209. Then, the repeat cell units 200C are piled together using gaskets 208 to achieve gas-tight seal between repeat cell units 205. The gasket material can, for example, be inorganic or metallic.

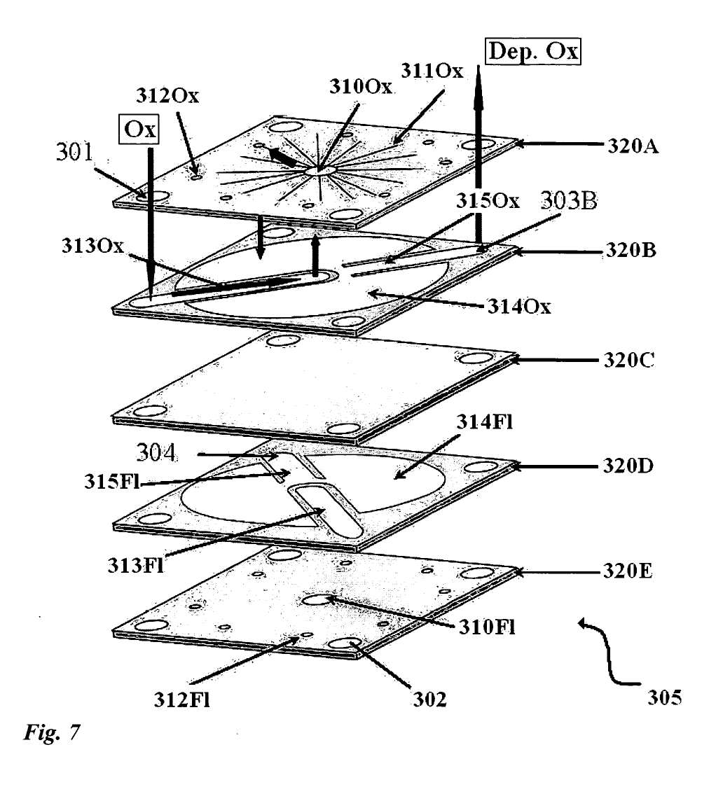

A useful component of this invention is a build-in gas manifold in the multi-layer interconnect. A simple manifold structure is illustrated in FIG. 7 (a break-up view). The primary conduits on the corners of the interconnect 305 are for oxidant inlet 301, fuel inlet 302, deplete oxidant outlet 303 and deplete fuel outlet 304. The interconnect 305 is constructed by five layers 320A, 320B, 320C, 320D and 320E. As illustrated with solid arrows, oxidant gas Ox moves, for example, through primary conduit 301, flows to the center of second layer 320B (an oxidant gas distribution layer) through channel 313Ox, and then flows into the top of first layer 320A through the internal distribution conduit 310Ox. Then, oxidant gas flows and reacts along the radial channels 311Ox on the top of first layer 300A to second distribution conduits 312Ox and flows back to second layer 320B, where the deplete gas Dep. Ox is manifolded through space 314Ox and channel 315Ox to deplete oxidant outlet 303. Channel 315Ox is optional, but it can help increase gas flow uniformity. Similarly, through the corresponding components labeled “Fl” instead of “Ox”, fuel gas flows to the center of fourth layer 320D (a fuel gas distribution layer) through primary conduit 302 and channel 313Ox. Then the fuel gas goes into the bottom of fifth layer 320E through internal conduit 310Fl, flows and reacts along the radial channels on the bottom of fifth layer 300E to second distribution conduits 312Fl and flows back to fourth layer 320D. The deplete fuel gas flows out of cell unit through open area 314Fl, optional channel 313Fl, and primary conduit 304. Third layer 320C is a separation layer between oxidant gas distribution layer 300B and fuel gas distribution layer 320D.

The material for the gas distribution layers 320B and 320D can be ceramic, which can be conductive, nonconductive with conducting vias or nonconductive ceramic. Since the interconnect needs to convey electrical potential, conductance can be provided though any of many avenues that will be apparent to those of skill. The material for layers 320A, 320C and 320E can be nonconductive ceramic with conducting vias, conductive ceramic, or, conveniently, metal. Layer 320C can be non-conductive ceramic. If layers 320A and 320E use metal, they could be metallically joined (e.g. welded) together along edges to ensure the electrical connection between layers 320A and 320E.

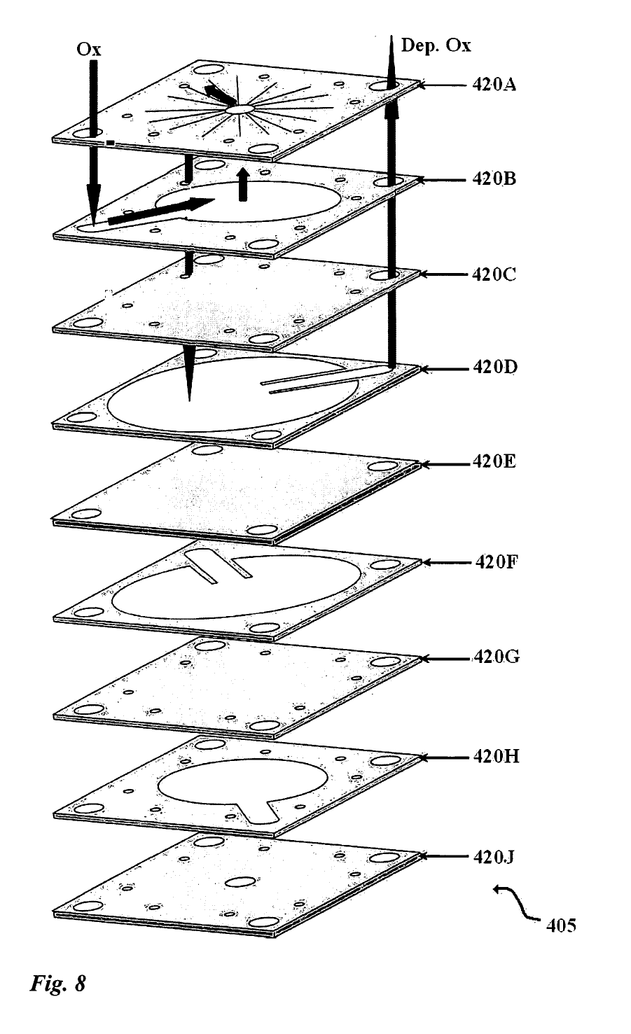

In some contexts, such as where a hydrocarbon fuel is reformed to provide hydrogen, it can be useful to extract heat from the fuel cell reaction into the initial manifold for fuel gas. A structure that provides such heat for both the oxidant gas and the fuel gas is illustrated by the multi-layer interconnect 405 shown in the break-up view of FIG. 8. For oxidant gas, the structure can provide pre-heating that helps increase reaction efficiency at the cathode electrode. This illustrated structure integrates oxidant gas pre-heater, hydrocarbon fuel reformer and gas manifold into the multi-layer interconnect. The oxidant gas distribution layer 320B in multi-layer interconnect 305 is replaced by three layers, including oxidant gas preheating layer 420B, separation layer 420C, and deplete oxidant gas layer 420D. Oxidant gas is heated in layer 420B due to the layer's proximity to the fuel cell disk above and the heated deplete gas cycled to fourth layer 420D below. Gas then goes into the top of first layer 420A for electrode reactions. The hot depleted oxidant gas flows to fourth layer 420D and exchanges heat with oxidant gas in second layer 420B through separation layer 420C. Similarly, the fuel gas distribution layer 320D in the multi-layer interconnect 320 is replaced by three layers, including deplete fuel gas layer 420F, separation layer 420G and fuel processing layer 420H. Hydrocarbon fuel gas, mixed with steam, is reformed on reforming catalyst placed in eighth layer 420H, and then the reforming gases flow to the bottom of ninth layer 420J for electrode reactions. The hot deplete fuel gases flow to layer 420F. The heat needed for reforming reactions in layer 420H is provided from hot deplete fuel gas and electrode reactions in adjacent layers 420F and 420J. In this structure, a useful material for top layer 420A, bottom layer 420H and separation layers 420C, 420E and 420G is metal or other material that provides good heat transfer. The top layer 420A and bottom layer 420J can be metallically joined (e.g. welded) together along the edges to ensure the electrical connection. It will be recognized that the extra layers for one gas handling side of the multilayer interconnect, such as for the oxidant gas or the fuel gas, can be compacted to the structure of FIG. 7.

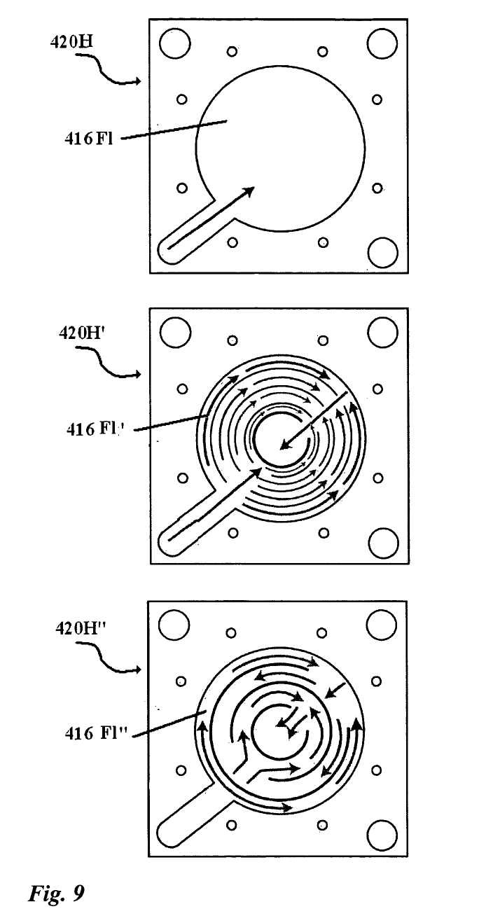

The structure of oxidant pre-heat layer 420B and fuel reforming layer 420H can be optimized for more symmetrical flow and temperature distribution. As shown in FIG. 9, fuel reforming layer 420H can be substituted with alternative layers such as layer 420H′ or 420H″. Appropriate baffles in preheat area 416Fl′ or 416Fl″ control gases flowing circularly in these layers. The fuel reforming catalyst can be placed in the fuel reforming layer accordingly to have endothermic reforming reactions take place at hot areas of the cell to improve temperature symmetry. Such baffles can be used in conjunction with a single manifold plate (per a given electrode) to position initial entry gas to receive heat from deplete gas.

The thickness of individual layer in the multi-layer interconnect is, for example, between 20 μm (20 micron) and 2000 μm, such as between 50 μm and 500 μm. In certain embodiments, the thickness is from greater than or equal to one of the following lower values to less than or equal to one of the following upper values. The lower values are 20, 25, 30, 35, 40, 45, 50, 100 and 200 micron. The upper values are 100, 200, 300, 400, 500, 750, 1000, 1500 and 2000 micron.

Certain fuel cell used in the invention can have edges that stay within or touching two circles with diameters +Value A and −Value B of a reference circle. Value A in certain embodiments can be 14%, 13%, 12%, 11%, 10%, 9%, 8%, 7%, 6%, 5%, 4%, 3%, 2% or 1% of the reference diameter.

In certain embodiments, the internal distribution conduit can be aligned with a point off the center of the fuel cell when the conduit's center is aligned within or touching a circle originating at fuel cell center and having diameter of B of the smallest width of the fuel cell. Value B in certain embodiments can be 14%, 13%, 12%, 11%, 10%, 9%, 8%, 7%, 6%, 5%, 4%, 3%, 2% or 1% of the smallest width.

This invention provides advantages for the fuel cell stack including:
1. Minimized internal thermal stress for reliable operation—the symmetrical flow passageway of oxidant and fuel gases will ensure a symmetrical gas flow and electrode reaction, and result in a symmetrical temperature distribution across the cell disk.
2. High fabrication yield for low cost fabrication—by using plain (no holes) planar tri-layer (cathode/electrolyte/anode) cell disk, the possible stress accumulation on the corners of cell disk can be reduced or eliminated, which will result in a high cell disk fabrication yield. The modular repeated cell unit structure can improve stack assembly yield. The stack sealing mechanism can increase the flatness tolerance, which will increase fabrication yield as well.
3. Integrating gas pre-heater and fuel reformer into fuel cell stack can provide high energy efficiency—The heat generated form electrode reactions could be consumed directly in stack by fuel reforming reactions and gas pre-heating. In addition, this integrated structure has advantage of easy stack heat management to avoid over-heating during operation.
   Corrugated Embodiments

In addition to use flat metal foil (or plate) in the multi-layer interconnect, the interconnect can also use corrugated metal foil (or plate). The corrugated metal layer can increase the bonding area of ceramic with metal, facilitate metal stress releasing through the corrugated shape, thereby making it more practical to use metallic materials that have larger CTE mismatch with ceramic components in the multi-layer interconnect structure.

Metal-Sandwiched Embodiments

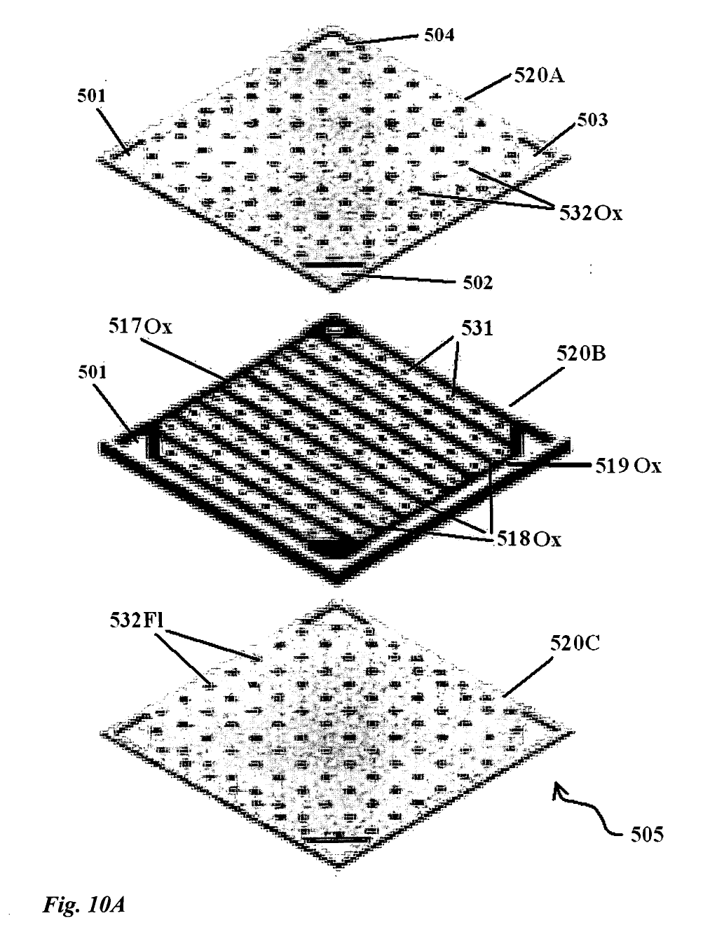

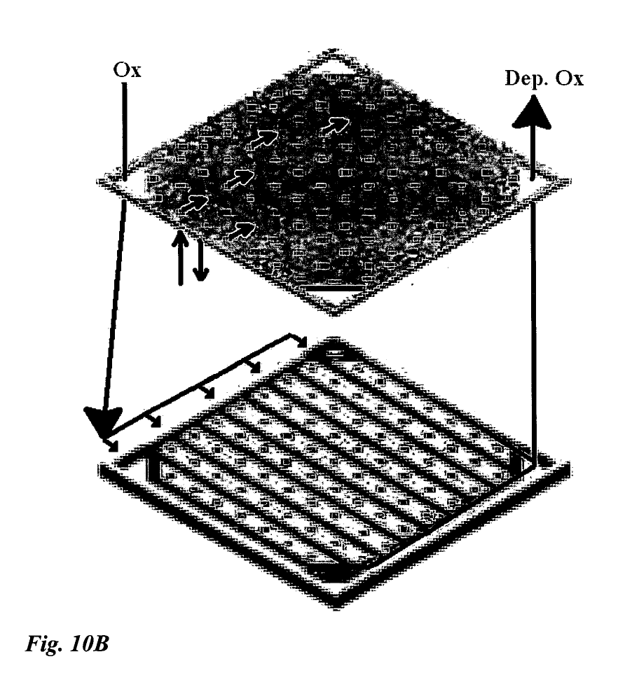

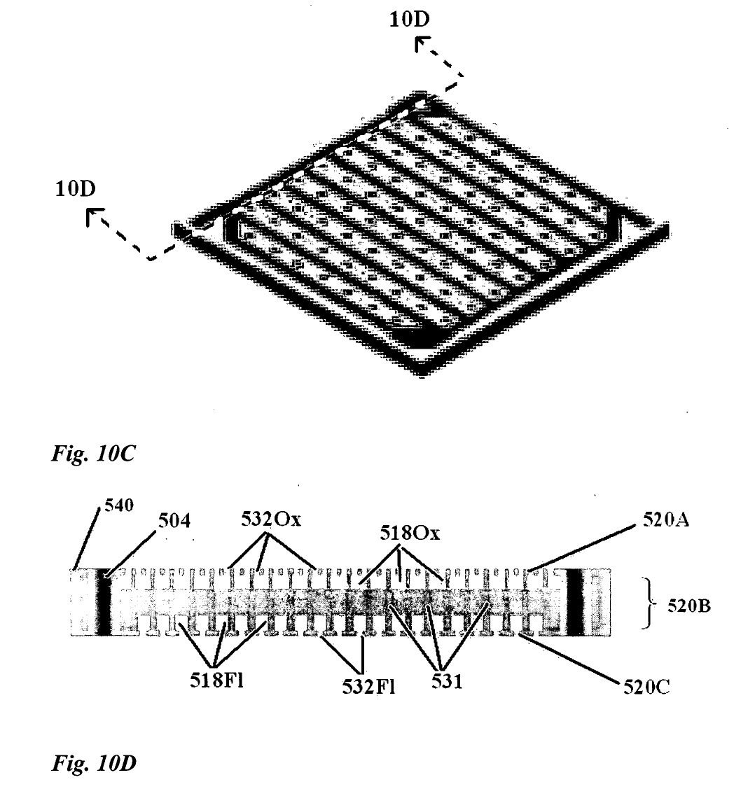

In addition to the radial flow stack structure, a multi-layer interconnect can have internal gas manifold structure with co flow and crossing-flow in square plate. As shown in FIG. 10A (perspective view, three separated layers) and FIG. 10C (side view, all three layers), an illustrative interconnect 505 can have four primary conduits (oxidant and fuel inlets and outlets) (501, 502, 503, 504) located in the corners or the side of the plate. Two separated sets of gas manifold conduits/channels are embedded on the opposite surfaces of the ceramic core layer 520B. On the illustrated side, these include first manifold conduit 517Ox, multiple second manifold conduits 518Ox, and third manifold conduit 519Ox. A pair of primary conduits (e.g., 501 and 503) is connected with one set of manifold conduits. Small distribution holes 532 are stamped in the surface metal layer 520A (e.g., a foil) above the manifold conduits to deliver gas for electrode reactions, and release reaction products. Therefore, in the proposed manifold, gases flow through the triangular (for illustration) primary conduit to the manifold conduits, then to electrodes through the small distribution holes 532. Depleted gases flow back to gas distribution channels, and then to the outlet triangular holes. This manifold structure can provide either co-flow (such as illustrated in FIG. 10B) or cross-flow (gas ingresses any given distribution hole 532 and may egress the same hole) of air or fuel gases at the opposite side of the interconnects. In many geometries of the fuel cell, cross flow is believed to provide greater thermal balance.

One exemplary pattern of flow is illustrated in FIG. 10B, where barriers to flow (not shown) provide that two of the primary conduits are isolated from the illustrated manifold channels, and that half of the second manifold channels serve to delivery gas, while the other half serve to collect depleted gas.

Electrical connection can be, for example, through the metal layers 520A and 520B, and conductive vias 531. Or, connectivity can be at the sides of the construct, such as by welded connections.

FIG. 10D shows a cut-away view oriented as shown in FIG. 10C. In the illustration, the second manifold channels 518Ox are parallel to second manifold channels 518Fl. Of course, these channels can be offset by 90 degrees. As illustrated, electrical connectivity can be by, or supplemented by, a welded end plate 540.

The sandwiched interconnect has useful strength, while minimizing the use of metal, providing weight reduction. The bulk of the interconnect can be made with a good CTE match in the x-y plane with the fuel cell disk, while the metal layers are kept compliant due to their strong binding to the ceramic center layer. Thus, this structure can be used in a device adapted to start fast (providing shifting thermal gradients), and excellent thermal cycling stability. The metal layers also serve to increase the conductance of electrons into or out of the adjacent electrode. In certain embodiments, electron flow is into or from the electrode, into or from a such metal layer, and into or from lateral conductors (such as welds),

The metallic layers (e.g., foil or plate) 520A and 520C can be flat as shown in FIG. 10D, or corrugated structure for a better CTE adjustment with ceramic layer to match the CTE with fuel cell components.

Composite Materials for CTE Matching

Comparing with ceramic interconnect materials, metallic interconnects are cheaper and a favorite for commercial applications. Due to the high operating temperature of solid oxide fuel cells (SOFC), the oxidation resistant properties of metallic interconnects are important for fuel cell stack performance. The sustained oxidation of metallic interconnect will result in a high stack internal resistance and reduce fuel cell stack performance. On the other hand, the thermal expansion coefficients (CTE) of metal components must be matched with other components of cell stack.

Zirconia based solid oxide fuel cells are the most common commercial fuel cells. The CTE of a zirconia based fuel cell disk is relatively small, such as about 11×10⁻⁶ 1/° C. Among high temperature alloys, only low Cr content stainless steel (such as 400 series stainless steel) has a roughly matched CTE. However, the oxidization resistant of this kind of alloy is not satisfactory at temperature higher than 650° C., which is the typical operation temperature of SOFCs. Although the high temperature oxidization resistance of some other alloys, such as 300 series stainless and Ni based high temperature alloys, is higher, these alloys are not satisfactory for use in zirconia based SOFCs due to their high CTE.

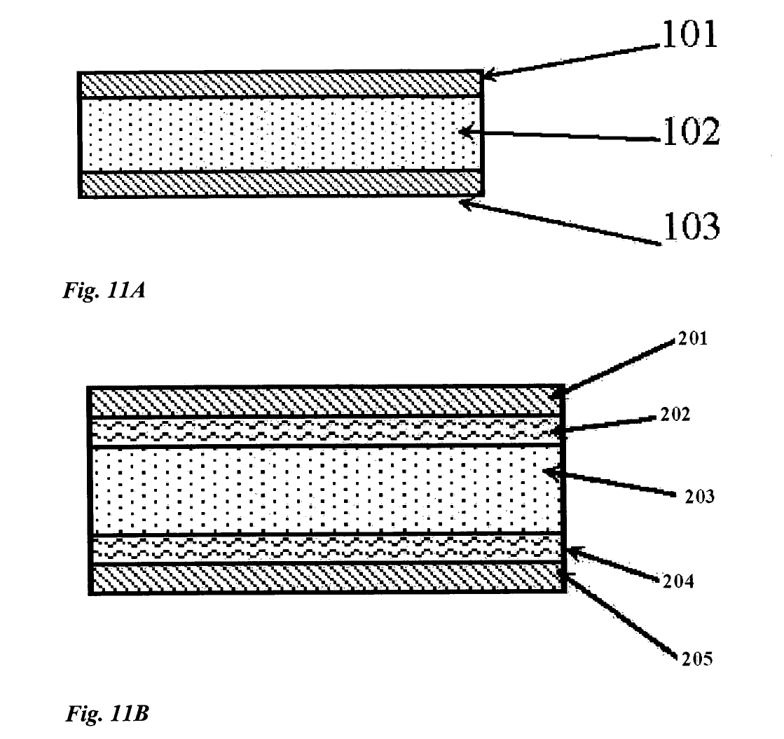

In this invention, a new structure is taught to modify CTE of high temperature alloy for fuel cell application. As shown in FIG. 11A, two thin layers of high temperature alloy (101, 103) are bonded on two sides of a glass ceramic core layer (102). Typically, CTE of alloy layer is much higher, and CTE of the ceramic core layer is lower than the CTE of the fuel cell disk (such as higher and lower than 11×10⁻⁶ 1/° C.). The thickness and the CTE of the ceramic core layer (102) are carefully selected. The final CTE of the multi-layer structure will be tailored to that of the fuel cell disks. Two alloy layers can be welded together along the edges to ensure the electrical connections.

If the CTEs difference of alloy layer and ceramic layer is too high, intermediate layers could be used in the structure. As shown in FIG. 11B, the CTE of the intermediate layers (202, 204) is between CTE of core layer (203) and alloy surface layer (201 and 205). This structure will reduce the bonding tension between core layer and alloy layers.

The metal/ceramic/metal composite is particularly suited for top and bottom layers in multi-layer interconnects. For example, these can be used to form first layer 320A, fifth layer 320E, first layer 420A and ninth layer 420J. Similarly, the corrugated structure described above can be useful in these top and bottom layers.

Publications and references, including but not limited to patents and patent applications, cited in this specification are herein incorporated by reference in their entirety in the entire portion cited as if each individual publication or reference were specifically and individually indicated to be incorporated by reference herein as being fully set forth. Any patent application to which this application claims priority is also incorporated by reference herein in the manner described above for publications and references.

While this invention has been described with an emphasis upon preferred embodiments, it will be obvious to those of ordinary skill in the art that variations in the preferred devices and methods may be used and that it is intended that the invention may be practiced otherwise than as specifically described herein. Accordingly, this invention includes all modifications encompassed within the spirit and scope of the invention as defined by the claims that follow.

What is claimed:

1. A fuel cell interconnect comprising:
a first primary conduit located at the periphery of the interconnect;
a second primary conduit located at the periphery of the interconnect;
a fuel cell distribution plate located at the top or bottom of the interconnect adapted to interface with a fuel cell and comprising: (i) an internal distribution conduit through the fuel cell distribution plate, and (ii) two or more second distribution conduits through the fuel cell distribution plate located peripheral to the internal distribution conduit but interior to the primary conduits, the internal and second distribution conduits adapted to convey fluid from one to the other along the top or bottom, as relevant, of the interconnect; and
one or more manifold plates comprising a conduit from the first primary conduit to the internal distribution conduit and a conduit from the second primary conduit to two or more said second distribution conduits.

2. The fuel cell interconnect of claim 1, wherein a fuel cell distribution plate is supplied gas from, and has gas removed to, a single manifold plate.

3. The fuel cell interconnect of claim 2, wherein the interconnect comprises a fuel cell distribution plate at the top, and one at the bottom.

4. The fuel cell interconnect of claim 1, wherein the interconnect comprises a fuel cell distribution plate at the top, and one at the bottom.

5. The fuel cell interconnect of claim 1, wherein a fuel cell distribution plate (a) is supplied gas from a supply manifold of an adjacent manifold plate, the supply manifold situated to receive heat from one side from the fuel cell and on another side from a deplete manifold, and (b) has gas removed to second manifold plate comprising the deplete manifold.

6. The fuel cell interconnect of claim 5, wherein the adjacent manifold plate is situated such that the manifolding space receives enough heat to increase the reforming efficiency of reforming reactions occurring in the space.

7. The fuel cell interconnect of claim 1, wherein the fuel cell is substantially round.

8. The fuel cell interconnect of claim 6, wherein the internal distribution conduit is aligned substantially with the center of the fuel cell.

9. The fuel cell interconnect of claim 1, wherein, for handling one of the two reactant gases, the interconnect consists essentially of one to two manifold plates.

10. The fuel cell interconnect of claim 1, wherein the distribution plate comprises two metal layers, and a ceramic layer sandwiched therebetween.

11. The fuel cell interconnect of claim 10, wherein the metal layers have a first CTE, the ceramic layer has a lower CTE, such that a resultant composite CTE is closer to the CTE of an adjacent fuel cell disk.

12. The fuel cell interconnect of claim 10, wherein the metal layers have a first CTE, the ceramic layer has three or more sublayers that, going from the metal layer to the center, have progressively lower CTEs, such that a resultant composite CTE is closer to the CTE of an adjacent fuel cell disk.

13. A fuel cell stack comprising:
two or more fuel cells connected with said interconnects of claim 1.

14. A fuel cell interconnect construct comprising:
a first primary conduit located at the periphery of the interconnect;
a second primary conduit located at the periphery of the interconnect;
a fuel cell layer;
a ceramic distribution plate comprising on a top side channels connected to the first primary conduit and the second primary conduit; and
sandwiched between the ceramic distribution plate and the fuel cell layer, an perforated metal layer, wherein the perforations convey gas from the channels to an electrode of the fuel cell layer.

15. The fuel cell interconnect construct of claim 14, comprising
a third primary conduit located at the periphery of the interconnect;
a fourth primary conduit located at the periphery of the interconnect; and
a second fuel cell layer;
wherein the ceramic distribution plate comprises on a bottom side channels connected to the third primary conduit and the fourth primary conduit,
and wherein a perforated metal layer is sandwiched between the ceramic distribution plate and the second fuel cell layer.

16. A fuel cell stack comprising:
three or more said fuel cell layers connected with said interconnect constructs of claim 14.
